(19) United States
(12) Patent Application Publication
(10) Pub. No.: US 2007/0298400 A1
(43) Pub. Date: Dec. 27, 2007

(54) Calendar-Based and Services-Oriented Bidding Process for Tutoring Request and Fulfillment

(76) Inventor: Kehinde Alabi, Rocky Point, NY (US)

Correspondence Address: Kehinde Alabi, 110 Friendship Drive, Rocky Point, NY, 11778, US

(21) Appl. No.: 11/306,355

(22) Filed: Dec. 23, 2005

(51) Int. Cl. G09B 3/00

(52) U.S. Cl. 434/350

(57) ABSTRACT

A tutoring request and fulfillment method and system based on a service-oriented bidding process is disclosed. The system employs a system of user-centric calendars to determine initial combinability of knowledge recipient with knowledge providers. Knowledge providers may bid for or be directly selected for knowledge requests. Out of a plurality of knowledge providers who bid for a request, the system provides open and validated information on the providers that enable the knowledge recipient or their agent to select a provider. Such information may include qualifications, experience, fee or rates, knowledge delivery history, and score or rating of the provider based on a scoring process within the system. The system also makes provision for knowledge delivery as well as for recording knowledge delivery sessions.

### REFERENCES CITED

U.S. Patent Documents

| | | | |
|---|---|---|---|
| 5,727,950 | August 2003 | Cook et. al. | 709/212 |
| 6,611,822 | August 2003 | Beams et. al. | 706/11 |
| 6,347,333 | February 2002 | Eisendrath et. al. | 709/217 |
| 6,341,960 | January 2002 | Frasson et. al. | 434/322 |
| 6,990,914 | February 2004 | Ramachandran et. al. | 434/350 |
| 6,785,676 | August 2004 | Oblinger | 707/5 |
| 6,347,333 | December 2001 | Chao et. al. | 434/322 |
| 10/882,811 | July 2004 | Alabi | 345/744 |

### OTHER PUBLICATIONS

Philip Greenspun, Internet Application Workbook, http://philip.greenspun.com/internet-application-workbook/4/2001.

Davies, J., et. al., “Knowledge Discovery and Delivery”, British Telecommunications Engineering, London, GB, vol. 17, No. 1, Apr. 1, 1998, pp. 25-35, XP-000765546.

Goker, A., “Capturing Information Need by Learning User Context”, 16^{th} International Joint Conference in Artificial Intelligence: Learning About User Workshop, Jul. 31, 1999, pp. 21-27, XP-002205013.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, TABLE, OR A COMPUTER PROGRAM LISTING COMPACT DISK, APPENDIX

Not Applicable

### BACKGROUND OF THE INVENTION

The current invention focuses on the process, system, and method of connecting students interested in learning a subject or subtopic of a subject with tutors who are able to impart that knowledge.

Learning and knowledge are an important part of our society. As a result, the continued improvement of our society is probably tied to the improvement of our knowledge delivery infrastructure and processes. Consequently, much innovation and policies have been focused on learning and knowledge delivery methods.

The evolution of knowledge delivery processes have given birth to structured learning environments including schools and colleges, work training programs, and more recently online and virtual learning environments. Also, the possession of a specific knowledge is recognized or somewhat measured by degrees, certificates, experience, and or other form of recognized document declaring completion of a test or metrics designed to determine the possession of said knowledge or skill. Historically, and currently, structured learning environments have been insufficient to provide all the learning needs of our society and supplemental learning as well as vocational learning have been a part of the society's composition. This includes after school programs, assistive-learning (AT) programs for permanent or temporarily disabled learners, as well as vocational learning programs. The current innovation pertains to the delivery of structured and mostly supplemental learning.

Online and computer-aided methods are being used increasingly in the delivery of knowledge and learning. Many of the technology-enabled knowledge delivery or delivery assistance innovations have focused on automating knowledge delivery processes, performing knowledge delivery remotely, and or using computer programs or intelligent agents to deliver mainstream or supplemental learning.

U.S. Pat. No. 5,727,950 (Cook, et. al, 2003) discloses a system for interactive computer-assisted learning sessions. In the invention, an intelligent agent acts as a virtual tutor and is based on the individual student's profile and learning needs.

U.S. Pat. No. 6,611,822 (Beams, et. al., 2003) describes a system that includes rule-based expert training to provide educational knowledge. The system provides the user with a simulated environment that presents a training opportunity to understand and solve problems optimally. The system also provides for “online classrooms” with application sharing, white-boarding, and discussion activities.

U.S. Pat. No. 6,347,333 (Eisendrath, et. al., 2002) discloses an online virtual campus that further addresses the administrative requirements of coordinating online knowledge delivery. The disclosure includes description for work storage, library management, grading, and management of learning history.

U.S. Pat. No. 6,341,960 (Frasson, et. al., 2002) describes a method and apparatus for agent-based automated delivery of tutoring. The intelligent delivery agent supports distance learning and can be invoked by the learner or on request. The agent may also be automatically invoked when it detects difficulties or deficiencies based on the learner's profile.

U.S. Pat. No. 6,690,914 (Ramachandran, et. al., 2004) introduced an agent based method that utilizes individual blackboards to coordinate the knowledge delivery process. Each blackboard is similar to patient charts in the medical field and contains logs or records of the progress and activities of the learner useful for coordinating the knowledge delivery process.

U.S. Pat. No. 6,785,676 (Oblinger, 2004) describes a self-service system that improves responses to requests by including annotations in the ordering process. When applied to education, the system is intended to help the identification of tutors to students. Of note is the improvement of the response presentation through the annotation system and the incorporation of historical responses in improving the relevance of presented responses.

U.S. Pat. No. 6,325,632 (Chao, et. al., 2001) describes a computer-aided method for matching students with tutors. The method introduces a user identifier that helps determine whether the user is a student or a tutor. Similar to online relationship matching processes, the method then includes provision for instructors to select students, students to select instructors, or automatic matching of students and instructors based on their profiles, subject of interest or ability. However, the method does not address the availability or schedule of the players or a fair means of selecting tutors amongst a plurality of equally matching tutors.

For the purposes of the current document, knowledge is here identified as a resource which is spread geographically, socially, can be imparted at any time, any location—remotely or via physical proximity between the learner and provider, and in different ways. In addition, the knowledge acquirer and provider can not be separated by one clear line in every context. In one context, a knowledge owner in the field of masonry may deliver said knowledge to a lawyer who wishes to put up a wall up at home, while in a different context the lawyer may teach the mason how to file taxes online. For this purpose, prior systems based on the clear demarcation of student and instructor user types begin to be difficult to utilize as enabling technology for delivering knowledge evolves. Such systems developed because of the initial duplication of traditional knowledge delivery structures such as in schools where tutors and students are almost exclusive roles. In addition, earlier application of emerging technology to knowledge delivery has been to apply automation to the delivery process via online instructive and collaborative environments, and agent based automatic knowledge delivery methods. These methods are doubtlessly useful but work best when structured and curriculum based learning is considered.

In the current invention, the learning process is unrestricted by user type, time, or location, and is intended to provide a user-centric environment where the selection power is retained on the demand or request side rather than on the supply or tutoring side. This is achieved via a calendar-based services oriented bidding process tailored to the knowledge delivery function. The objective is to improve the access to knowledge providers by those requiring said knowledge.

The development of the preferred embodiment occurred over a significant time frame. A prior incarnation of the method allowed the selection of tutors by students and vice-versa. Anyone with the knowledge of the current problems on the Internet will recognize the potential for excessive solicitation and badgering. This was the result of this experiment. This method did not work well in this situation but may be more suited to a structured learning environment with authority figures. A later incarnation allowed responses to tutoring requests and needs to be on a first responder basis of all possible matching tutors. This removes the power and control from the learner and again will work best for younger learners who may better repose the decision on their learning needs with some authority. The final and current implementation is based on a bidding-type process morphing the power of online product bidding processes, with search, request and response procedures into a calendar-based service bidding process with provision for curriculum and structured learning processes as well as automated knowledge delivery.

### BRIEF SUMMARY OF THE INVENTION

The present invention describes the process of connecting students to tutors via an online calendar-based, tutoring services-oriented bidding process.

An overall objective of the invention is to create a fair knowledge market where knowledge providers can connect with those requiring said knowledge—both roles being based on context, have many-to-many relationship, and any role can be assumed by any player in this market place depending on subject, time, or place. Obviously, an embodiment that chooses to retain an absolute differentiation of both roles will be a subset of the current description.

A related objective of the invention is to provide a services-oriented online bidding method to the process of connecting knowledge providers or tutors with those requiring knowledge or students. A part of this process is the description of user-centric calendars that contain information on the availability of each user in the system.

It is yet another objective to provide complete information on knowledge providers as transparently as possible so that a fair comparison among all potential knowledge providers is available to knowledge requesters in selecting a provider and assigning a value to pay for the acquisition of said knowledge. Towards this end, the invention includes procedures for rating and providing feedback on knowledge providers that will form a historical trail which establishes the worth or value of the knowledge delivery potentials of that provider.

Consistent with the availability of information equally and fairly is the verification and validation of all claims of knowledge ownership or expertise by knowledge providers. The value of delivery of that knowledge is then market determined and based on the level of expertise and accumulated worth of prior knowledge delivery of the knowledge provider. Each provider may set their own rate or the rate may be automatically computed by the system. In any case, the intention of the current invention is that the eventual knowledge delivery rate of each provider will be related to the worth of the knowledge delivery potential as measured by metrics described subsequently.

A first step in the process of connecting knowledge providers to students would be via a request. Such a request may be automatically invoked via recognition of knowledge needs—procedures that are described in prior art. The request may also be initiated by the knowledge recipient or one acting on their behalf.

The second step is the process of connecting knowledge providers to knowledge recipients. To this end exists a system of user-centric calendars that allows a full disclosure of availability of knowledge providers within the time frame of the knowledge recipients. A match may require simultaneous matching of one or more variables including subject, and/or subtopic of interest, language of instruction, knowledge delivery rate or cost, and coincident availability as indicated by each user's calendars.

Out of a plurality of available matching providers, the third step involves a bidding process among the knowledge providers for delivery of said knowledge to the beneficiary of the request. The factors that determine the choice of the successful provider includes the level of expertise, fees or rate, prior worth of knowledge delivery as measured by previous knowledge session feedback provided about the provider, and history or knowledge of the abilities of the knowledge provider. The eventual decision or choice is intended to remain with the requestor or an authority for making such decisions on behalf of the requestor.

It is the intention of the current invention that similar to any fair market where knowledge is completely open, the rate of each provider will always adjust to match the true value of their knowledge delivery potentials as measured by the factors described above.

The current invention does not preclude the possible bypass of the third step, by which a knowledge requester simply proceeds to select a knowledge provider based on a knowledge-based comparison of all providers with compatible availability or any other reasons for preferring chosen provider such as prior interaction with the said provider.

A further step involves the payment process. The determination of online knowledge delivery can be measured by the system whereas offline knowledge delivery may occur directly between provider and knowledge recipient. In the current embodiment, the provider retains the responsibility for indicating the duration of the knowledge delivery session. In another embodiment, the knowledge provider may be required to obtain a consenting document from the knowledge requestor confirming the duration of the session. In yet another embodiment, a witnessing party may be required to be present to confirm the duration of the knowledge delivery session. This together with the effect of the feedback of the recipient on the future and current worth of the provider is a feature that is intended to provide a fair operating knowledge market.

### BRIEF DESCRIPTION OF THE DRAWINGS

FIG. 1 is a diagram that includes elements of a system operating the current invention.

FIG. 2 is a diagram demonstrating the steps whereby a knowledge request is made and the process of responding to said request.

FIG. 3 is a diagram demonstrating the step whereby the knowledge requestor selects a knowledge provider out of a plurality of providers that have responded to a knowledge request.

FIG. 4 is a diagram demonstrating the step in which a knowledge provider confirms a knowledge request.

FIG. 5 is a diagram demonstrating the step in which connected knowledge recipients and providers communicate and meet to deliver said knowledge.

FIG. 6 demonstrates a possible bypass of the bidding and selection process.

FIG. 7 illustrates a possible implementation of a calendar for knowledge providers.

FIG. 8 illustrates a possible implementation of a calendar for knowledge recipients.

FIG. 9 illustrates a possible implementation of the open-bid request calendar.

FIG. 10 illustrates a possible implementation of a detail view of an item in a calendar.

### DETAILED DESCRIPTION OF THE INVENTION

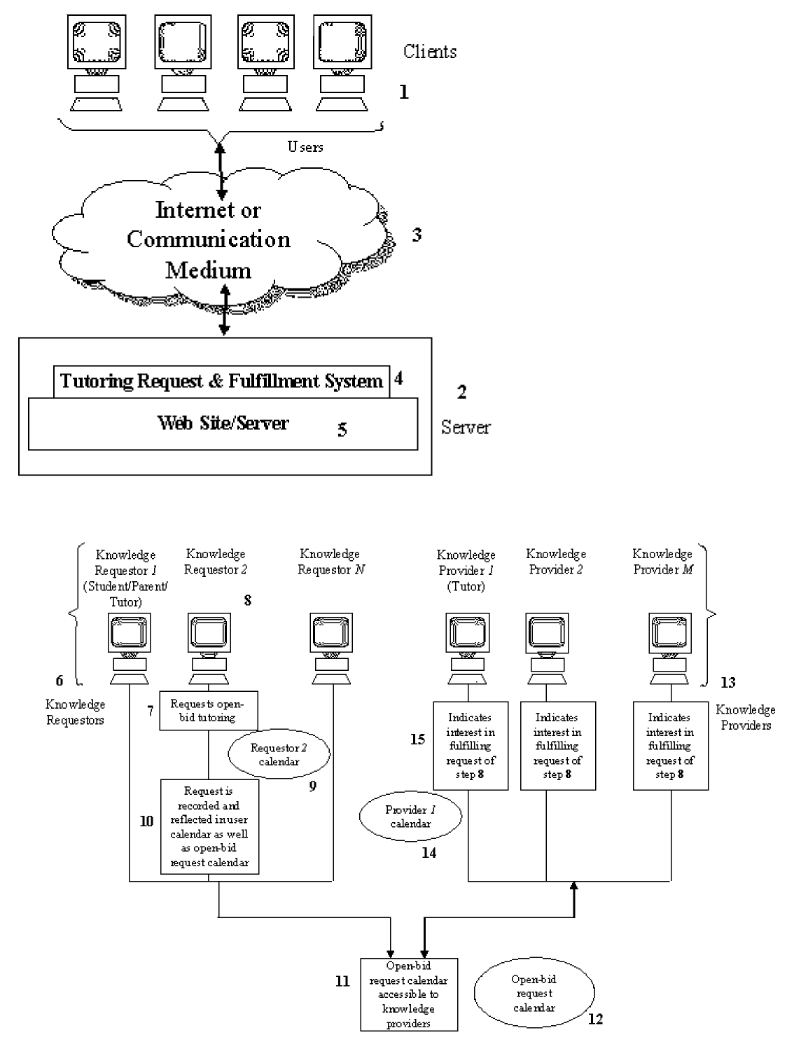

In the preferred embodiment, the current invention may be implemented on a client server system or a peer-to-peer network. The connection between the client and the server may be any network device, wireless system, the Internet or the Intranet. Referring to FIG. 1, users 1 accessing through client systems may interact with the server system operating the current invention 2 via a network such as the Internet or other network communication medium 3. Resident on the host system would be applications 5 which are developed to utilize the current invention, or have been imparted with provisions described herein, and a web server 6 or server management system. These applications will subsequently be referred to as a knowledge request and fulfillment management system and will contain functions and programs implemented according to the descriptions disclosed here.

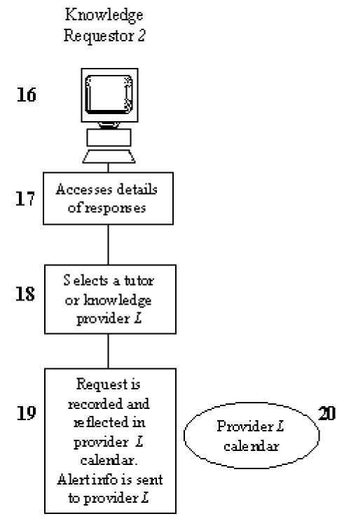

The service-oriented bidding process is subsequently explained via a series of flow diagrams presented in FIGS. 2 through 4. The system of calendars central to the process are also depicted in the figures with elliptical symbols not connected to the flow diagrams.

Referring to FIG. 2, which contains a plurality of knowledge requestors 6, we consider a knowledge request 7 entered into the system by or on behalf of knowledge requestor 2 8 (The details of the GUI process for recording a request may be according to U.S. patent application Ser. No. 10/882,811). The process responds by recording the knowledge request on a calendar dedicated to Requestor 2 9. In addition, the request is also entered into an open-bid request calendar 12 accessible to all knowledge providers qualified to deliver the knowledge requested.

The figure also shows a plurality of knowledge providers 13 numbering from 1 to a number M, who are qualified to deliver the requested knowledge, and whose dedicated calendars 14 has opening to fulfill said request. Each knowledge provider may then indicate interest 15 or have their interest indicated on their behalf. This completes the initial request and response step.

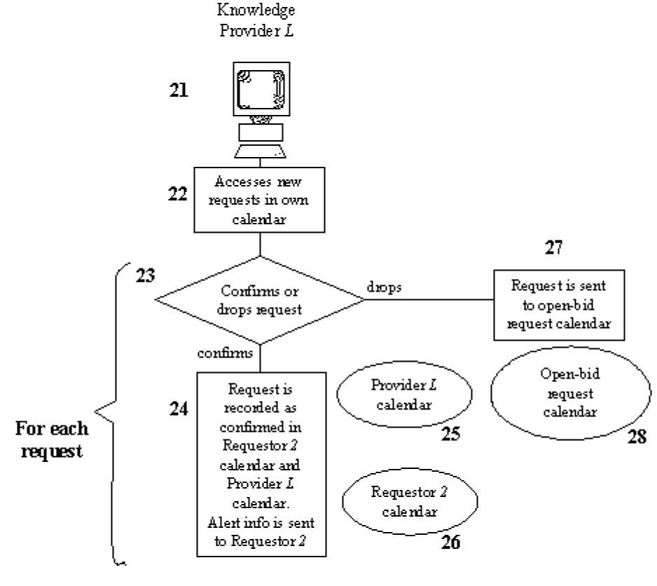

FIG. 3 illustrates the step in which the knowledge requester 2 16, or some authority acting on behalf of the said knowledge requester accesses responses to the request 17 and selects a knowledge provider 18, L (1≦L≦M), based on a comparative analysis of data containing at least of the following: qualifications, profile, ratings, and comments from other users that have received similar knowledge from the said knowledge provider.

The selection of a knowledge provider results in a recording of the knowledge request 19 in that provider's dedicated calendar 20 and an alert being generated to the provider. The alert may be sent via email, instant message, wireless message, or some other form of communication. It is intended that the presence or absence of the alert or the mechanism used to send it is not intended to affect the spirit of the current invention.

FIG. 4 illustrates the step in which selected knowledge provider 21, L, accesses requests newly 22 entered into his/her dedicated calendar. The knowledge provider at this point can decide whether to confirm or drop the request 23. Again, the presence or absence of the confirmation/drop step is not intended to affect the spirit of the current invention.

If the knowledge provider proceeds to confirm the request, the request is recorded 24 as confirmed in the knowledge requesters dedicated calendar 25 as well as the knowledge provider's dedicated calendar 26.

If the knowledge provider drops or rejects the request 27, the request is returned to the open-bid calendar 28 where other knowledge providers may access the request to indicate interest in possibly fulfilling it.

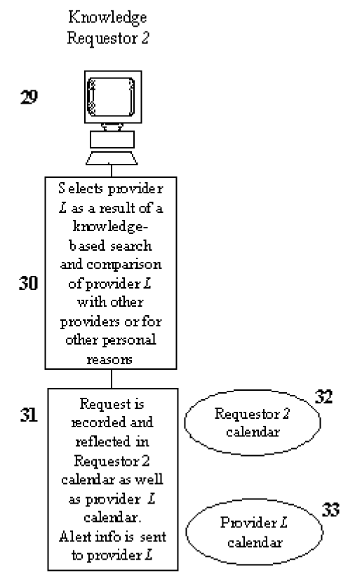

A bypass to the bidding process, illustrated in FIG. 5, may occur in situations in which the knowledge requestor 29, or one with authority to act on their behalf, directly selects a knowledge provider 30 after an informed comparison based on at least of the following: cost or rate of knowledge delivery, level of expertise as indicated in the system, ratings and/or comments from other knowledge recipients that have worked with the provider or other measure of knowledge delivery abilities of the provider. The knowledge provider may also be directly selected due to some previous knowledge of the provider or simply based on some other preferences of the requestor or one with authority to act on their behalf. In this bypass situation, a request is generated and recorded 31 in the requestor's dedicated calendar 32 as well as in the selected provider's dedicated calendar 33. The method then proceeds as described in FIG. 4.

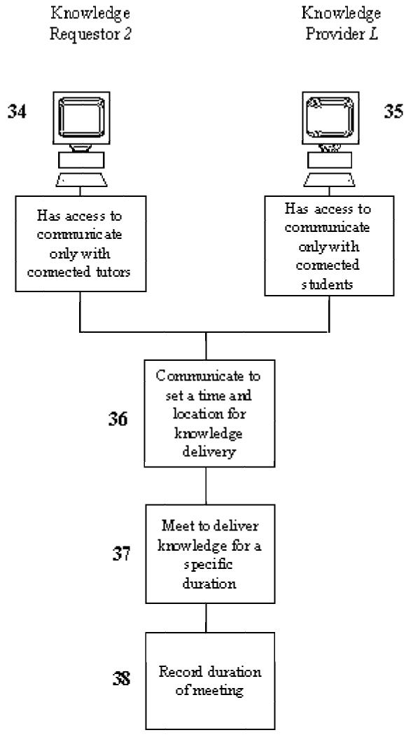

Following the connection of a knowledge provider and recipient, FIG. 6, the system provides them with access or information required to communicate with each other 34, 35. This may be via email, instant message, phone, conference, or other means of communication. The provider and recipient may then set a time and location 36 and proceed to meet and deliver required knowledge 37. Following the knowledge delivery step, the provider may record the duration of the knowledge delivery session 38. In the case of an online session, the duration may be automatically determined by the system. Additionally, the provider may be given the authority to further qualify the recorded duration. For sessions that are not online or can not be determined automatically by the system, the provider may be required to obtain some verification of the duration from the knowledge recipient or one acting on their behalf. Further, the system may require or provide for a witness to a knowledge delivery session. The presence or absence of the provision for modifying automatically recorded sessions or that of requiring additional verification for sessions that are not automatically recorded is not intended to affect the spirit of the current invention.

FIG. 7 through 10 shows an implementation of the user-centric calendars necessary for the initial matching of knowledge providers to a specific knowledge request. In FIG. 7, the form of the calendar may include entries that indicate when a provider is available 39, unavailable 40, or both. In addition, the calendar will provide information of when the provider already has a session scheduled 41.

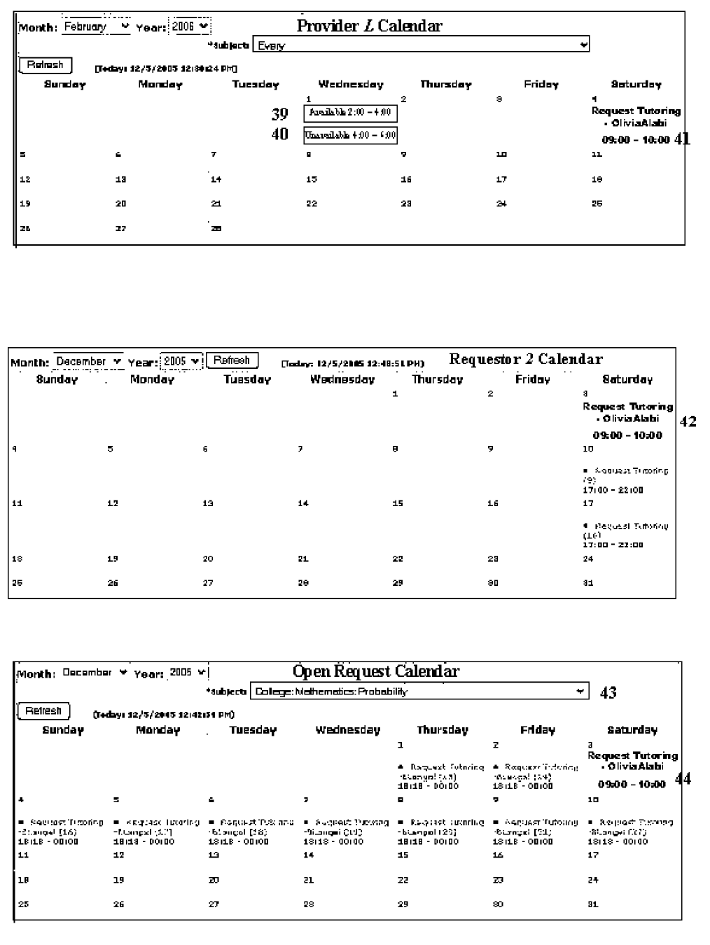

FIG. 8 shows an implementation of a knowledge recipient's calendar. The calendar indicates when the recipient has a knowledge session scheduled 42. The calendar may also further indicate which of the sessions have been confirmed or not.

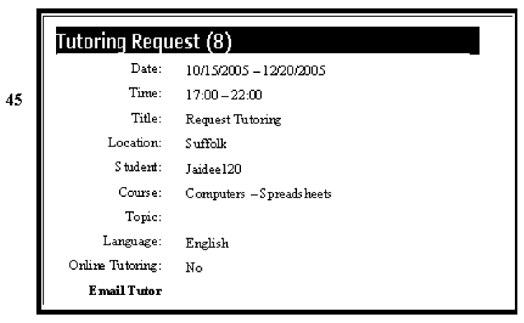

FIG. 9 contains an implementation of the open-bid calendar. The calendar contains request items 43 that are up for bidding by knowledge providers. A requirement of this calendar would be sorting mechanisms such as sorting by subject 44 that allows a well subscribed calendar to remain navigable and/or easy to obtain information from.

A feature common to all the calendars in the current embodiment is the summary of the request information whose details may be accessed individually. FIG. 10 shows typical details 45 of on of the requests on the calendar. The level of details may be a function of who is accessing the information and or the state of the request—whether confirmed or not, in bidding or assigned. In the implementation described here, the details may simply be accessed by clicking on the request item in any of the calendars. However, one familiar with the current art may recognize that the type of graphical user interface used for the current implementation or the method for accessing the details of the calendar or even the complete presentation of the details on the calendars are not intended to limit the spirit of the current invention.

What is claimed is:

1. A tutoring request and fulfillment method involving users including at least one knowledge provider and one knowledge recipient in one context and comprising the steps of:
Initiating the request by the knowledge recipient user or by one acting on behalf of said user;
Responding to the request by one or more knowledge providers indicating interest in fulfilling the request;
Selection of a knowledge provider based on one measure of the ability of the provider or simply based on a preference of the recipient user or one acting on behalf of said user;
Delivery of knowledge between knowledge provider and knowledge recipient;
Recording of the duration of the session or other measure of the amount of knowledge delivered.

2. A tutoring request and fulfillment method involving users including at least one knowledge provider and one knowledge recipient in one context and comprising the steps of:
Initiating the request by the knowledge recipient user or by one acting on behalf of said user;
Selection of a knowledge provider based on one measure of the ability of the provider or simply based on a preference of the recipient user or one acting on behalf of said user;
Delivery of knowledge between knowledge provider and knowledge recipient;
Recording of the duration of the session or other measure of the amount of knowledge delivered.

3. The method described in 1 and 2 further consisting of a schedule of calendars assigned to each user that determines their availability for tutoring.

4. The method described in 1 whereby the response by knowledge providers is based on an initial match in the schedule of the knowledge provider compatible with the time required for knowledge delivery.

5. The method described in 2 whereby the selection of a knowledge provider is based on an initial match in the schedule of the knowledge provider compatible with the time required for knowledge delivery.

6. The method described in 1 and 2 whereby the measure of the ability of a knowledge provider is based on at least one of the following:
Qualifications;
Experience;
Comments and feedback from other knowledge recipients that have engaged in knowledge exchange with said provider;
Some aggregated score or rating maintained by the system based on a history of knowledge delivery session involving said knowledge provider.

7. The method described in 1 and 2 consisting of the step of verifying knowledge providers to validate their claims of ability to deliver said knowledge.

8. The knowledge delivery method described in 1 and 2 which can be delivered via an online session or a face-to-face meeting or an assignment of reading or studying or provision of educational material or content.

9. The knowledge delivery method described in 1 and 2 comprising either an automatic record of its duration or measure by the system when the knowledge delivery is online within the system, or a manual record by the knowledge provider when the knowledge delivery is offline.

10. The manual record method of 9 containing provision for a witnessing document from the recipient user or one acting on behalf of the said user or requiring a third-party witness.

11. The method described in 1 and 2 containing provision for indicating a preferred rate or fee while initiating a knowledge request.

12. The method described in 1 containing provision for accompanying an indication of interest in fulfilling a request with a rate or fee offer for fulfilling said request.

13. A tutoring request and fulfillment system involving users including at least one knowledge provider and one knowledge recipient in one context and comprising the steps of:
Initiating the request by the knowledge recipient user or by one acting on behalf of said user;
Responding to the request by one or more knowledge providers indicating interest in fulfilling the request;
Selection of a knowledge provider based on one measure of the ability of the provider or simply based on a preference of the recipient user or one acting on behalf of said user;
Delivery of knowledge between knowledge provider and knowledge recipient;
Recording of the duration of the session or other measure of the amount of knowledge delivered.

14. The system described in 13 with provision for directly selecting a knowledge provider based on a preference of the requester or based on a comparative analysis of potential knowledge providers available to fulfill a request.

15. The system described in 13 and 14 further consisting of a system of calendars assigned to each user that determines their availability for knowledge exchange.

16. The system described in 13 whereby the response by knowledge providers is based on an initial match in the schedule of the knowledge provider compatible with the time required for knowledge delivery.

17. The system described in 14 whereby the selection of a knowledge provider is based on an initial match in the schedule of the knowledge provider compatible with the time required for knowledge delivery.

18. The system described in 13 and 14 whereby the measure of the ability of a knowledge provider is based on at least one of the following:
Qualifications;
Experience;
Comments and feedback from other knowledge recipients that have engaged in knowledge exchange with said provider;
Some aggregated score or rating maintained by the system based on a history of knowledge delivery session involving said knowledge provider.

19. The system described in 13 and 14 consisting of the step of verifying knowledge providers to validate their claims of ability to deliver said knowledge.

20. The knowledge delivery process described in 13 and 14 which can be delivered via an online session or a face-to-face meeting or an assignment of reading or studying or provision of educational material or content.

21. The knowledge delivery method described in 13 and 14 comprising either an automatic record of its duration or measure by the system when the knowledge delivery is online within the system, or a manual record by the knowledge provider when the knowledge delivery is offline.

22. The system described in 13 and 14 containing provision for indicating a preferred rate or fee while initiating a knowledge request.

23. The system described in 13 containing provision for accompanying an indication of interest in fulfilling a request with a rate or fee offer for fulfilling said request.

24. The system described in 13 and 14 containing provision for including a subject that was not hitherto included in the system while initiating the request.
